(19) United States
(12) Patent Application Publication
(10) Pub. No.: US 2011/0046759 A1
(43) Pub. Date: Feb. 24, 2011

(54) METHOD AND APPARATUS FOR SEPARATING AUDIO OBJECT

(75) Inventors: Hyun-wook KIM, Suwon-si (KR); Han-gil MOON, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/697,647

(22) Filed: Feb. 1, 2010

(30) Foreign Application Priority Data
Aug. 18, 2009 (KR) 10-2009-0076337

(51) Int. Cl. G06F 17/00

(52) U.S. Cl. 700/94

(57) ABSTRACT

Provided is a method of separating an audio object that includes extracting virtual source location information and an audio signal from a bitstream, separating an object included in the audio signal based on a virtual source location, mapping objects of a previous frame and objects of a current frame located at the virtual source location, and extracting the mapped objects between continuous frames.

### CROSS-REFERENCE TO RELATED PATENT APPLICATIONS

This application claims priority from Korean Patent Application No. 10-2009-0076337, filed Aug. 18, 2009, in the Korean Intellectual Property Office, the disclosure of which is incorporated herein in its entirety by reference.

### BACKGROUND

1. Field

Exemplary embodiments relate to a multichannel audio codec apparatus, and more particularly, to a method and apparatus for separating a meaningful object from an audio signal by using sound image location information.

2. Description of the Related Art

As home theater systems become popular, multichannel audio processing systems are being developed. Multichannel audio processing system may encode or decode a multichannel audio signal by using a side information, for example, space parameters.

An audio encoding apparatus may down-mix a multichannel audio signal and encode a down-mixed audio signal by adding space parameters thereto. An audio decoding apparatus subsequently up-mixes the down-mixed audio signal by using the space parameters, into the original multichannel audio signal. The audio signal may include a plurality of audio objects. The audio objects are components constituting an audio scene, for example, vocal, chorus, keyboard, drum, and others. The audio objects are previously mixed through a mixing process, such as by a sound engineer.

The audio decoding apparatus in, for example, a home theatre, separates a object from audio when it is needed by a user, such as if a user desires to listen to an isolated vocal track or to a single musical instrument among a plurality of instruments. However, in a conventional audio object separation method, since the objects are separated from the down-mixed audio signal, complexity is increased and the separation is inaccurate and difficult. Thus, the audio decoding apparatus requires a solution to efficiently separate objects from the multichannel audio signal.

### SUMMARY

Aspects of exemplary embodiments may provide a method and apparatus for separating an audio object from a multichannel audio signal by using virtual source location information (VSLI).

According to an aspect of an exemplary embodiment, a method of separating an audio object may include extracting virtual source location information and an audio signal from a bitstream, separating an object included in the audio signal based on a virtual source location, mapping objects of a previous frame and objects of a current frame located at the virtual source location, and extracting the mapped objects between continuous frames.

The separating of an object may include determining sub-bands existing at the virtual source location with respect to a frame as a temporary object, and checking movements of sub-bands of the temporary object and determining the temporary object as a valid object if the sub-bands of the temporary object move in a direction.

The determining of a temporary object may include extracting virtual source location for each sub-band and energy for each sub-band in a frame, selecting a sub-band having the largest energy from the sub-bands, extracting a plurality of sub-bands existing at the virtual source locations by using a predefined function with respect to the selected sub-band, and determining the extracted plurality of sub-bands as a temporary object.

In the determining of a valid object, a difference value between a virtual source location at which sub-bands of a temporary object of a previous frame exist and a virtual source location at which sub-bands of a temporary object of a current frame exist, may be obtained. When the difference value is less than a critical value, the temporary object may be determined as a valid object.

In the mapping of objects, a check parameter between an object of a previous frame and an object of a current frame may be defined, and a variety of conditions may be created by combining the check parameter between the objects and identity between the objects may be determined according to the condition.

According to another exemplary aspect of exemplary embodiments, an apparatus for separating an audio object may include an audio decoding unit extracting an audio signal and virtual source location information from a bitstream, an object separation unit separating an object from the audio signal based on the virtual source location information extracted by the audio decoding unit and sub-band energy, and an object mapping unit mapping objects of a previous frame and objects of a current frame located at a virtual source location based on a plurality of check parameters.

### BRIEF DESCRIPTION OF THE DRAWINGS

The above and other features and aspects of exemplary embodiments will become more apparent by describing in detail exemplary embodiments thereof with reference to the attached drawings in which:

FIG. 1 is a block diagram of an exemplary apparatus for separating an object from sound according to an exemplary embodiment of the present invention;

FIG. 2 is a flowchart for explaining an exemplary method of separating an object from sound according to an exemplary embodiment of the present invention;

FIG. 3 is a flowchart for explaining an exemplary method of separating an object from the audio signal of FIG. 2;

FIG. 4 is an exemplary graph showing a relationship between a virtual source location and sub-band energy;

FIG. 5 is a flowchart for showing an exemplary method of tracing a movement of an object;

FIG. 6 illustrates a relationship of source position between the components of objects of a previous frame and those of a current frame;

FIG. 7 is a flowchart for showing an exemplary process of mapping an object between frames of FIG. 2;

FIG. 8 illustrates an example of listening to a desired object only by using an object separation algorithm according to an exemplary embodiment of the present invention; and

FIG. 9 is illustrates an example of synthesizing an object by using an object separation algorithm according to an exemplary embodiment of the present invention.

### DETAILED DESCRIPTION OF EXEMPLARY EMBODIMENTS OF THE INVENTION

The attached drawings for illustrating exemplary embodiments of the present invention are referred to in order to gain a sufficient understanding of aspects of embodiments of the present invention. Hereinafter, aspects of exemplary embodiments of the present invention will be described in detail by explaining exemplary embodiments of the invention with reference to the attached drawings. Like reference numerals in the drawings denote like elements.

An encoding apparatus may generate a down-mixed audio signal by using a plurality of audio objects and may generate a bitstream by adding a space parameter to the down-mixed audio signal. The space parameter may include additional information such as a side information that may include virtual source location information.

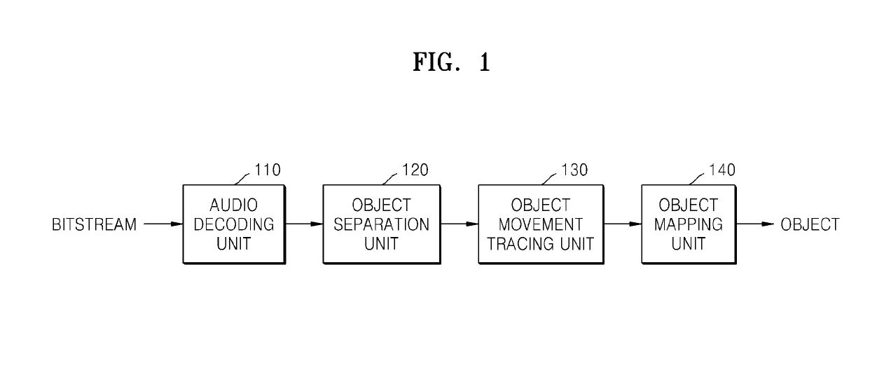

FIG. 1 is a block diagram of an exemplary apparatus for separating an audio object according to an exemplary embodiment of the present invention. Referring to FIG. 1, the apparatus for separating an audio object according to the present exemplary embodiment may include an audio decoding unit 110, an object separation unit 120, an object movement tracing unit 130, and an object mapping unit 140.

The audio decoding unit 110 may extract audio data and a side information from a bitstream. The side information may include virtual source location information (VSLI). The VSLI may include azimuth information which represents geometric spatial information between power vectors of interchannel frequency bands.

In another exemplary embodiment, if the VSLI does not exist in the side information, the audio decoding unit 110 may extract VSLI for each subchannel by using a decoded audio signal. For example, the audio decoding unit 110 may virtually assign each channel of a multichannel audio signal on a semicircular plane and extract a virtual source location represented on the semicircular plane based on, for example, the amplitude of a signal of each channel.

The object separation unit 120 may separate objects included in the audio signal for each predetermined unit, such as a frame, by using the VSLI and additional information, such as the energy of each sub-band extracted by the audio decoding unit 110. The object movement tracing unit 130 may verify a specific object based on characteristics of the objects, such as the movements of the objects separated by the object separation unit 120.

The object mapping unit 140 may map objects of a previous frame and objects of a current frame corresponding to a virtual source location based on information such as the virtual source location, a frequency component, and energy if validity of the object is verified by the object movement tracing unit 130, and may extract mapped objects or objects for each frame.

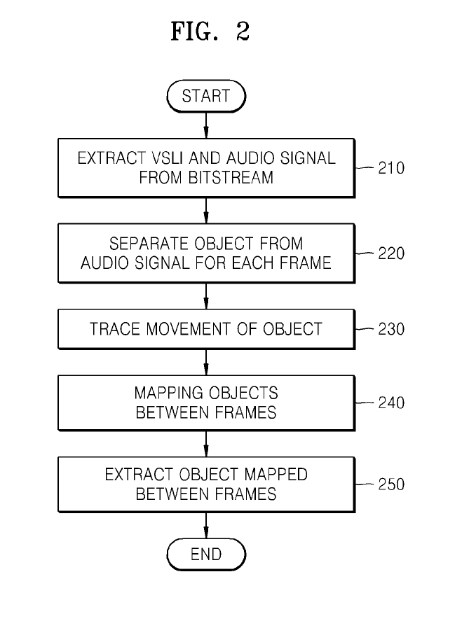

FIG. 2 is a flowchart for explaining an exemplary method of separating an object from sound according to an exemplary embodiment of the present invention. Referring to FIG. 2, first, a bitstream in which VSLI is added to audio data is received. The VSLI and the audio data may be extracted from the bitstream (Operation 210). Although the VSLI may be extracted from the side information, in another exemplary embodiment, the VSLI may be extracted based on other parameters, such as the amplitude of an audio signal of each channel. In another exemplary embodiment, the virtual source location may be replaced by a codec parameter indicating a position.

An object included in the audio signal may be separated based on the virtual source location and energy for each sub-band (Operation 220). That is, sub-bands corresponding to the virtual source position may be designated as a temporary object in a single frame.

The sub-bands of an object of the previous frame and those of the current frame may be compared and a movement of a corresponding object may be traced (Operation 230). That is, the movements of sub-bands included in the temporary object may be checked and, if the sub-bands are determined to move in a direction, the temporary object may be designated as an effective object. Accordingly, a meaningful object may be determined from the audio signal by checking the movement of the object.

The objects of the previous frame and those of the current frame existing at the virtual source location may be mapped with each other to confirm the homogeneity of the objects for each frame (Operation 240). That is, the objects generated in the same source may be traced by comparing the objects between adjacent frames.

For example, if a piano object and a violin object exist in a previous frame and the piano object 1, the violin object 2, and a flute object 3 exist in a current frame, the piano object of the previous frame and the piano object of the current frame may be mapped with each other and the violin object of the previous frame and the violin object of the current frame may be mapped with each other.

The mapped objects between frames may be extracted by using mapping information between the previous frame and the current frame (Operation 250). Using the objects in the previous example, the objects mapped between the frames may be the piano object and the violin object 2. Accordingly, although a plurality of a side information are needed to separate an object from the audio signal in a related art, in exemplary embodiments of the present invention, the object may be separated from the audio signal with decoding information or the VSLI, without separate side information.

Also, as an applied exemplary embodiment, one or more desired objects of the objects separated from the audio signal may be synthesized, for example, separating out a flute object and a drums object. Furthermore, as another applied exemplary embodiment, a specific object may be lowered in level or set silent from among the objects separated from the audio signal, for example, muting a vocal object and not a corresponding musical accompaniment.

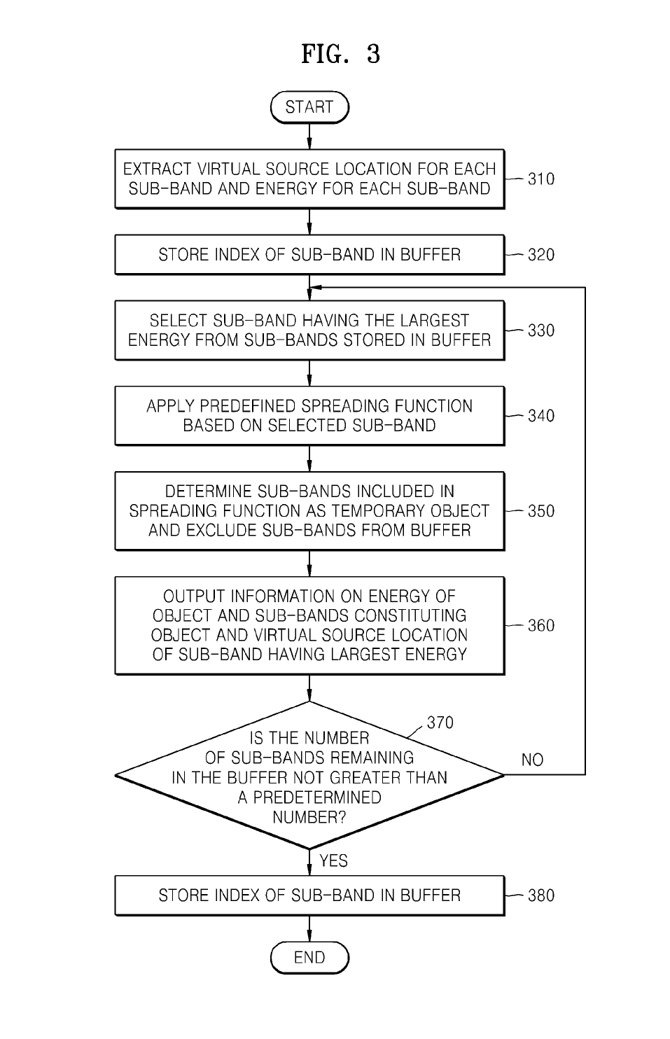

FIG. 3 is a flowchart for explaining an exemplary method of separating an object from an audio signal of FIG. 2. Referring to FIG. 3, the VSLI and energy for each sub-band may be extracted from an audio signal in predetermined units, such as frames (Operation 310). Indexes of the sub-bands may be stored in a buffer (Operation 320). A sub-band may be selected by using a predetermined parameter, such as the sub-band having the largest energy from the sub-bands stored in the buffer (Operation 330).

A predefined spreading function may be applied to the selected sub-band (Operation 340). The frequency components of objects may be extracted by use of the spreading function in a frame. The spreading function may be expressed in a variety of ways. For example, the spreading function may be expressed as the following two equations of the first degrees (1) and (2).

y=ax+b (1)

y=−ax+c (2)

In the above exemplary equations, “a” represents a slope of a line, and “b” and “c” represent Y-intercepts which may vary according to, for example, the energy and virtual source location of a central sub-band.

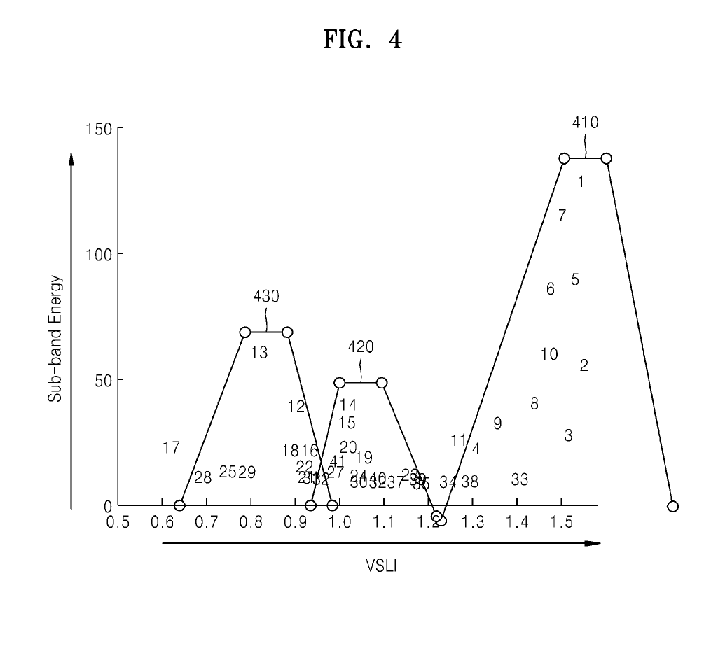

FIG. 4 is an exemplary variance graph of sub-bands belonging to a particular exemplary object using the spreading function. In the graph, the x-axis denotes the VSLI and the Y-axis denotes sub-band energy. Also, the numbers included in the spreading function are indexes of the sub-bands.

For example, as illustrated in FIG. 4, the sub-bands “7”, “5”, “6”, “10”, . . . included in a first degree equation 410 may be extracted by applying the spreading function with respect to the sub-band having the largest energy. Accordingly, the sub-bands included in the first degree equation 410 are determined to be first temporary objects. The sub-bands of the first temporary objects exist, as shown in FIG. 4, in a virtual source location range of approximately “1.3-1.5”.

Referring to FIG. 3, the sub-bands included in the spreading function may be determined to be a single temporary object and may be excluded from the buffer (Operation 350). Information, such as the VSLI of the sub-band having the largest energy, information on the sub-bands forming the object, and information on the energy of the object may be output (Operation 360).

It may be checked whether a number of sub-bands remaining in a buffer is not greater (i.e., equal to or less than) than a predetermined number (Operation 370). When the number of the sub-bands remaining in the buffer is not greater than a predetermined number, the indexes of the sub-bands are stored in the buffer and the temporary object may be output (Operation 380). When the number of the sub-bands remaining in the buffer is greater than a predetermined number, the program may go back to the operation 330 to determine again the temporary object.

For example, a sub-band “13” having the largest energy may be selected from the remaining sub-bands except for the sub-bands of the first temporary object, as illustrated in FIG. 4. Sub-bands “12”, “25”, “28”, “29”, . . . included in the first degree equation 430 may be extracted by applying the spreading function with respect to the sub-band “13”. Thus, the sub-bands included in the first degree equation 430 are determined to be a second temporary object. The sub-bands of the second temporary object exist in a virtual source location range of approximately “0.65-1.0”.

Also, a sub-band “14” having the largest energy may be selected from the remaining sub-bands except for the sub-bands of the second temporary object. Sub-bands “15”, “19”, “27”, “41”, . . . included in a first degree equation 420 may be extracted by applying the spreading function with respect to the sub-band “14”. Thus, the sub-bands included in the first degree equation 420 may be determined to be a third temporary object. The sub-bands of the third temporary object exist in a virtual source location range of approximately “1.0-1.2”.

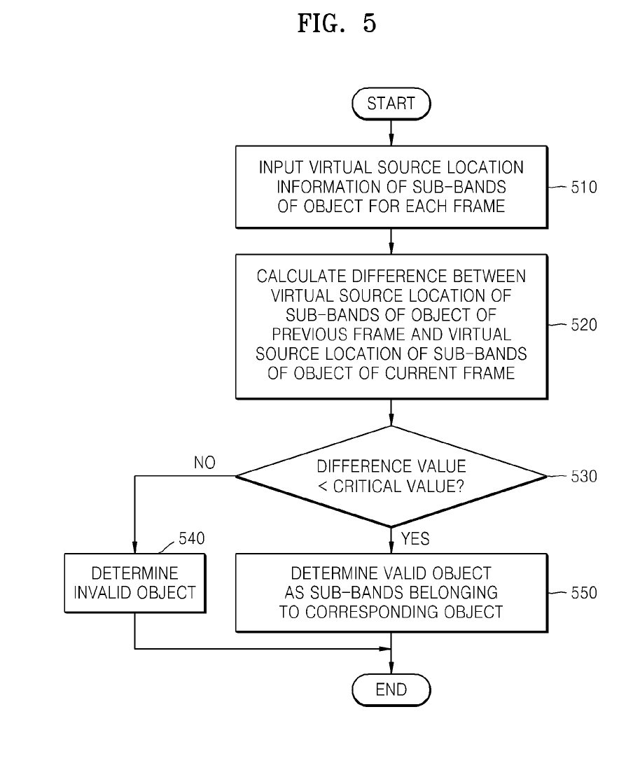

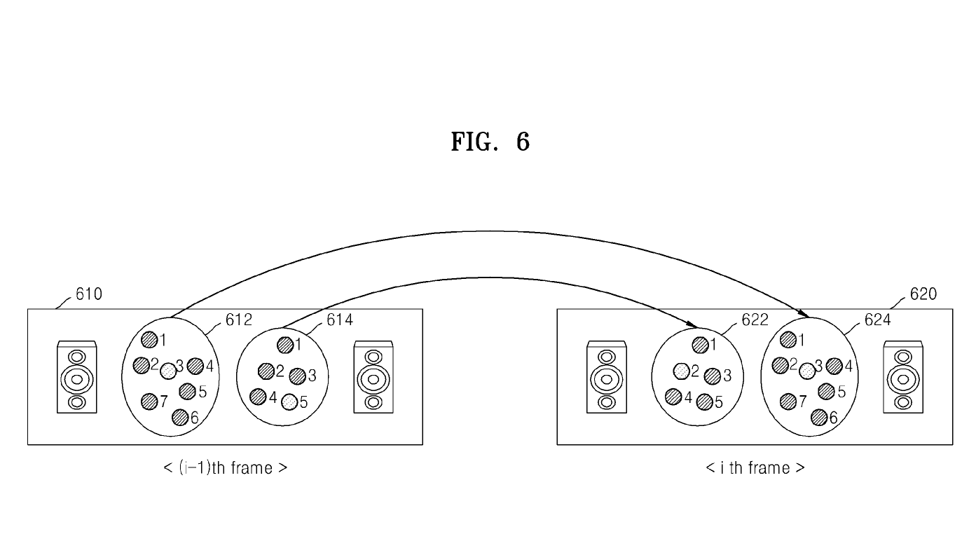

FIG. 5 is a flowchart for showing an exemplary method of tracing a movement of an object. Referring to FIG. 5, first, the VSLI of the sub-bands belonging to a temporary object may be input for each frame (Operation 510), as sound images of objects output at the same location may exist at similar locations and may show similar movements. For example, assuming that audio signals in units of frames are continuously generated as illustrated in FIG. 6, the sub-bands 1-5 of the first object 622 and the sub-bands 1-7 of the second object 624 in the current (i th) frame 620 exist at the source locations similar to the sub-bands 1-7 of the first object 612 and the sub-bands 1-5 of the second object 614 in the previous (i-1 th) frame 610.

A difference between virtual source locations of the sub-bands of the previous frame and those of the current frame may be calculated (Operation 520). The difference value may correspond to the movements of the sub-bands of the object.

The movement variance of the sub-bands belonging to the temporary object is obtained and the movement variance value of the sub-bands and a predetermined critical value may be compared with each other (Operation 530). It may be determined that there is a movement of a corresponding object as the movement variance value of the sub-bands decreases.

When the variance value of the sub-bands is smaller than the critical value, the sub-bands of the temporary object may be determined to have moved together. Accordingly, if the variance value of the sub-bands is smaller than the critical value, the sub-bands of the temporary object may be moved together so that the temporary object may be determined to be a valid object (Operation 550).

However, if the variance value of the sub-bands is greater than the critical value, the sub-bands of the temporary object may be determined to be moved differently. That is, if the variance value of the sub-bands is greater than the critical value, the temporary object may be determined to be an invalid object (Operation 540).

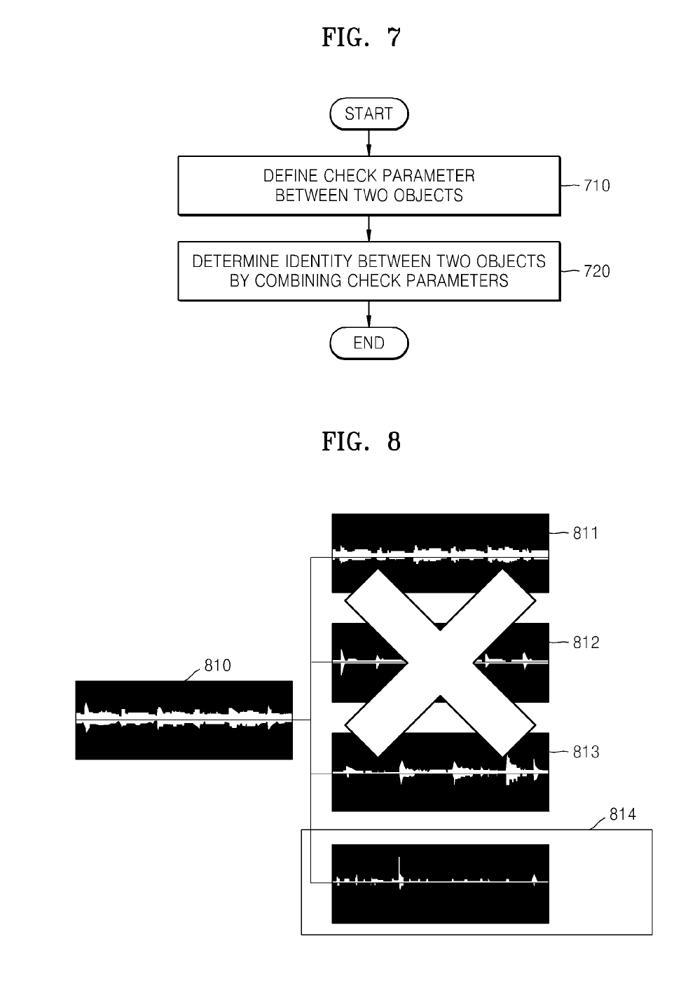

FIG. 7 is a flowchart for showing an exemplary process of mapping an object between frames of FIG. 2. Referring to FIG. 7 a check parameter between the object of the previous frame and the object of the current frame is defined (Operation 710). For example, to trace whether two objects are output from the same source, three check parameters “loc_chk”, “sb_chk”, and “engy_chk” are defined as the following Equations 1, 2, and 3.

The check parameter “loc_chk” denotes relative locations of the two objects. The check parameter “sb_chk” denotes how similar the frequency components of the two objects are to each other on a frequency domain. The check parameter “engy_chk” denotes a relative difference in energy between the two energies.

$$loc\_chk = \frac{\vert 2 ( ct\_obj \_loc ( 2 ) - ct\_obj \_loc ( 1 ) ) \vert}{π} \qquad [ Equation 1 ]$$

In Equation 1, “ct_obj_loc(1)” denotes the VSLI of the central sub-band in the current frame, and “ct_obj_loc(2)” denotes the VSLI of the central sub-band in the previous frame.

$$sb\_chk = 1 - \frac{size ( obj\_sb ( 2 ) ⋂ obj\_sb ( 1 ) )}{max ( \begin{matrix}size ( obj\_sb ( 2 ) ) , \\ size ( obj\_sb ( 1 ) )\end{matrix} )} \qquad [ Equation 2 ]$$

In Equation 2, “obj_sb(1)” denotes a collection of the indexes of sub-bands of the object in the current frame, and “obj_sb(2)” denotes a collection of the indexes of sub-bands of the object in the previous frame.

$$engy\_chk = \frac{\vert obj\_e ( 2 ) - obj\_e ( 1 ) \vert}{max ( obj\_e ( 2 ) , obj\_e ( 1 ) )} \qquad [ Equation 3 ]$$

In Equation 3, “obj_e(1)” denotes the energy of the object in the current frame, and “obj_e(2)” denotes the energy of the object in the previous frame.

Referring back to FIG. 7, the identity between the two objects may be determined by combining the check parameters of the objects (Operation 720). In other words, a variety of conditions may be created by combining the three check parameters defined by the Equations 1, 2, and 3 and, if at least one of the conditions are satisfied, the two objects may be determined to be the same object.

That is, if “sb_chk<th1”, since the two objects have similar frequency components, the two objects may be determined to be the same object (the critical value th1 having been previously determined).

If “loc_chk<th2 and engv_chk<th3”, since the generation locations and energy of the two objects are similar to each other, the two objects may be determined to be the same object (the critical values th2 and th3 having been previously determined). For example, if a piano plays the note C and the note A, although the frequency components of the piano are different from each other, the generation location and the energy of the object may have hardly changed

If “sb_chk<th4 and loc_chk>th5”, although there is a difference between the relative positions of the two objects, since the frequency components are similar to each other, the two objects may be determined to be the same object (the critical values th4 and th5 having been previously determined).

Accordingly, the objects for each frame may be mapped to each together by determining identity between the two objects.

FIG. 8 illustrates an example of listening to a desired object by using an audio object separation algorithm according to an aspect of an exemplary embodiment of the present invention. Referring to FIG. 8, for example, if a listener desires to hear cello sound 814 only from a sound source 810 paying orchestra music, an audio object separation algorithm according to an exemplary embodiment of the present invention may separate the cello sound 814 and set the other sounds 811, 812, and 813 to a different output level, or silent. Accordingly, a listener may hear the cello sound 814 unaccompanied by other sounds present in sound source 810.

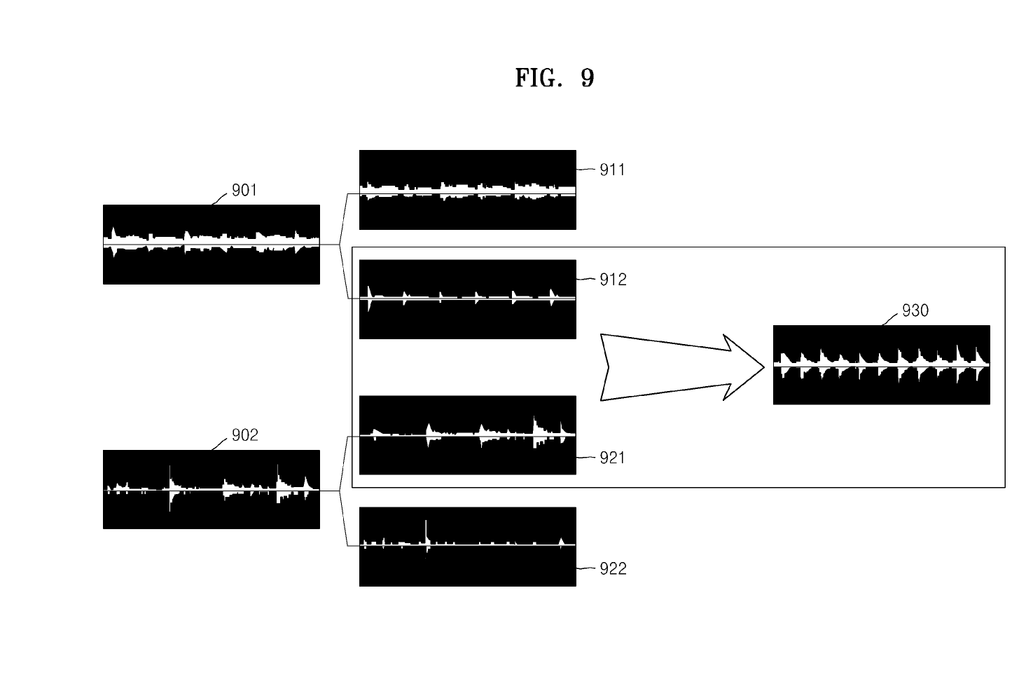

FIG. 9 is illustrates an example of synthesizing an object by using an audio object separation algorithm according to another exemplary embodiment of the present invention. Referring to FIG. 9, for example, assuming for the example that a sound source 901 contains a background music 911 and a soprano voice 912 corresponding to objects, and a sound source 902 contains a background music 921 and a tenor voice 922 corresponding to objects, if an editor desires to mix the soprano voice 912 with the background music 921 instead of the background music 911, according to a aspect of an exemplary embodiment of the present invention, the soprano voice 912 may be separated from the sound source 901 and the background music 921 may be separated from the sound source 902, by using an object separation algorithm according to an exemplary embodiment of the present invention. The background music 921 and the soprano voice 912, separated from the sound sources 901 and 902, may then be synthesized, as represented by sound 930 of FIG. 9.

Aspects of exemplary embodiments of the present invention may be embodied as computer executable codes embodied on a tangible computer readable recording medium. The computer readable recording medium is a tangible data storage device that can store data which can be thereafter read by a computer system. Non-limiting examples of computer readable recording media include non-volatile read-only memory (ROM) or random-access memory (RAM), CD-ROMs, magnetic tapes, floppy disks, optical data storage devices, hard discs, and others.

While this invention has been particularly shown and described with reference to exemplary embodiments thereof, it will be understood by those skilled in the art that various changes in form and details may be made therein without departing from the spirit and scope of the invention as defined by the appended claims. Additionally, exemplary embodiments of the present invention, while shown in examples with a bitstream of multi-channel audio source, are not limited thereto, and aspects of exemplary embodiments of the present invention may be applied to audio in both analog and digital formats, audio packaged or encoded with or without video information, and an audio source with multiple audio objects in mono, stereo, and discrete or combined multi-channel formats (e.g., 5.1 and 7.1 channel).

Additionally, expressions such as “at least one of”, when preceding a list of elements, modify the entire list of elements and do not modify each element of the list. It will also be understood by one of skill in the art that the terms such movement, direction, separation, plane, vector, and location may represent spatial locations or changes in a time domain, and these terms may also represent dimensions, values or changes to values in volume, amplitude, power, frequency, or other characteristics in a time, frequency, energy, or other domain, and accordingly, these and similar terms should not be interpreted to be limited to representing a spatial displacement of a sound source over time, e.g., a singer walking across a stage. Terms used such as frames may indicate a predetermined period of time, a predetermined amount of information or memory, a predetermined data unit, and other predetermined units.

What is claimed is:

1. A method of separating an audio object among a plurality of audio objects in an audio signal, the method comprising:
extracting a virtual source location information and the audio signal from a bitstream;
separating at least one audio object in the audio signal based on a virtual source location of the virtual source location information;
mapping objects of a previous frame and objects of a current frame located at the virtual source location; and
extracting the mapped objects between continuous frames.

2. The method of claim 1, wherein the virtual source location information is extracted from a side information of the bitstream, or is based on an amplitude of a plurality of audio channels of the audio signal.

3. The method of claim 1, wherein the separating the at least one audio object comprises:
determining sub-bands existing at the virtual source location with respect to a frame as a temporary object; and
checking movements of sub-bands of the temporary object and determining the temporary object as a valid object if the sub-bands of the temporary object move in a determined direction by a determined amount.

4. The method of claim 3, wherein the determining of a temporary object comprises:
extracting virtual source locations for each of the sub-bands, and an energy for each of the sub-bands, in a frame;
selecting a sub-band having a largest energy from the sub-bands;
extracting a plurality of sub-bands existing at the virtual source location of the selected sub-band by using a predefined function; and
determining the extracted plurality of sub-bands as a temporary object.

5. The method of claim 4, wherein the predefined function is a spreading function using the virtual source location for each of sub-bands, and the energy for each of sub-bands.

6. The method of claim 4, wherein the spreading function is a predetermined number of first degree equations, and an intercept of each of the predetermined number of first degree equations is determined according to a virtual source location and an energy of a central sub-band.

7. The method of claim 3, wherein, in the determining of a valid object, a difference value between a virtual source location at which sub-bands of a temporary object of a previous frame exist and a virtual source location at which sub-bands of a temporary object of a current frame exist, is obtained,
a variance value of movements of the sub-bands is obtained, based on the difference value, and
the temporary object determined in the determining of a temporary object is determined as a valid object if the variance value of movements of the sub bands is less than a predetermined critical value.

8. The method of claim 1, wherein, in the mapping of objects, a check parameter between an object of the previous frame and an object of the current frame is defined, and a variety of conditions are created by combining the check parameter with the objects, and identity between the objects is determined according to at least one of the variety of conditions.

9. The method of claim 1, wherein, in the mapping of objects, identity of objects for each frame is determined by comparing a difference in frequency component, a difference in relative location, and energy between objects for each frame with a predetermined critical value for each said comparison.

10. The method of claim 9, wherein the relative location difference between the objects is obtained based on virtual source location information of a central sub-band of each object.

11. The method of claim 9, wherein, in the determining of identity of objects for each frame, two objects are determined to be the same object when any of
a first condition in which a difference in frequency component between the two objects is less than a first predetermined critical value,
a second condition in which a difference in generation location and a difference in energy between the two objects is less than a second predetermined critical value, and
a third condition in which the difference in frequency component between the two objects is less than the first predetermined critical value and the difference in generation location between the two objects is greater than the second predetermined critical value, is satisfied.

12. The method of claim 9, wherein the difference in frequency component between the objects is obtained based on indexes of sub-bands of each object.

13. The method of claim 1, further comprising synthesizing particular objects of the at least one audio objects separated from the audio signal.

14. The method of claim 1, further comprising setting particular objects of the at least one audio objects separated from the audio signal.

15. An apparatus for separating an audio object among a plurality of audio objects in an audio signal, the apparatus comprising:
an audio decoding unit which extracts the audio signal and a virtual source location information from a bitstream;
an object separation unit which separates at least one audio object from the audio signal based on the virtual source location information extracted by the audio decoding unit and a sub-band energy; and
an object mapping unit which maps objects of a previous frame and objects of a current frame, located at a virtual source location of the virtual source location information, based on a plurality of check parameters.

16. The apparatus of claim 15, further comprising an object movement tracing unit that verifies a validity of one of the plurality of audio objects based on a movement of the at least one audio object separated by the object separation unit.

17. The apparatus of claim 15, wherein the plurality of check parameters are a difference in frequency component, a difference in virtual source location, and a difference in energy between objects.

18. A tangible computer readable recording medium having recorded thereon a computer program for executing the method defined in claim 1.

19. The method of claim 1, wherein the plurality of audio objects comprises a voice object, a first instrument object, and a second instrument object.

20. An apparatus for separating a plurality of audio objects in an audio signal, the apparatus comprising:
an audio decoding unit which extracts the audio signal and a virtual source location information, from an input signal;
an object separation unit which separates the plurality of audio objects from the audio signal, based on the virtual source location information extracted by the audio decoding unit and a sub-band energy; and
an object mapping unit which maps an object of a previous frame and an object of a current frame, located at a virtual source location of the virtual source location information.
